(19) United States
(12) Patent Application Publication
(10) Pub. No.: US 2015/0239750 A1
(43) Pub. Date: Aug. 27, 2015

(54) IODINE ADSORBENT, WATER TREATMENT TANK AND IODINE ADSORBING SYSTEM

(71) Applicant: KABUSHIKI KAISHA TOSHIBA, Tokyo (JP)

(72) Inventors: Tomohito IDE, Tokyo (JP); Yumiko Sekiguchi, Kawasaki (JP); Arisa Yamada, Kawasaki (JP); Toshihiro Imada, Kawasaki (JP)

(21) Appl. No.: 14/631,163

(22) Filed: Feb. 25, 2015

(30) Foreign Application Priority Data
Feb. 27, 2014 (JP) 2014-036460

(51) Int. Cl. C02F 1/28; B01J 20/22

(52) U.S. Cl. CPC C02F 1/285; B01J 20/223; C02F 2101/12

(57) ABSTRACT

An iodine adsorbent of an embodiment includes a support, an organic group bonded to the support, silver, and chloride ions, bromide ions, or both of chloride ions and bromide ions. The organic group has, at the terminal, a functional group represented by S⁻ or SR. The silver is bonded to S⁻ or sulfur in SR. The R is a hydrogen atom or a substituent containing a hydrocarbon.

### CROSS-REFERENCE TO RELATED APPLICATION

This application is based upon and claims the benefit of priority from Japanese Patent Application No. 2014-036460 Feb. 27, 2014; the entire contents of which are incorporated herein by reference.

### FIELD

Embodiments described herein relate to an iodine adsorbent, a method for producing an iodine adsorbent, a water treatment tank and an iodine adsorbing system.

### BACKGROUND

Iodine is used for pharmaceutical products such as X-ray contrast agents and germicides, intermediate materials and catalysts for chemical synthesis, herbicides and feed additives, and in addition, polarizing plates for LCD have recently come into use, thus increasing the demand for iodine. On the other hand, iodine is required to be collected and recycled from wastewater because there are few concentrated resources of iodine in nature, and in recent years, environmental regulations have been tightened. In case of nuclear disaster, iodine is released into the air, and dissolved in rain water, river water and the like to cause a problem.

As the iodine adsorbent, activated carbon, silica gel and alumina each supported with silver ions, and zeolite substituted with silver ions are known. However, when these materials are used in water, silver loaded on the surface may be eluted in the case of silver-loaded materials, and silver may be eluted by ion exchange in the case of silver zeolite. Silver is a heavy metal and toxic, and therefore causes environmental pollution when released into the environment. Silver may corrode a metal which is used for pipes etc. and has a standard electrode potential lower than that of silver.

### BRIEF DESCRIPTION OF THE DRAWINGS

FIG. 1 is a conceptual view of an iodine adsorbing system of an embodiment; and

FIG. 2 is a sectional schematic view of a water treatment tank of an embodiment.

### DETAILED DESCRIPTION

An iodine adsorbent of an embodiment includes a support, an organic group bonded to the support, silver, and chloride ions, bromide ions, or both of chloride ions and bromide ions. The organic group has, at the terminal, a functional group represented by S⁻ SR. The silver is bonded to S⁻ or sulfur in SR. The R is a hydrogen atom or a substituent containing a hydrocarbon.

A method for producing an iodine adsorbent of an embodiment includes, for example, silver loading to a support, which has an organic group having at the terminal a functional group represented by S⁻ or SR, by contact with a solution of organic salt or inorganic salt containing silver; and treating a silver contained support with an aqueous solution containing chloride ions, bromide ions, or both of chloride ions and bromide ions.

A water treatment tank of an embodiment has an iodine adsorbent. The iodine adsorbent includes a support, an organic group bonded to the support, silver, and chloride ions, bromide ions, or both of chloride ions and bromide ions. The organic group has, at the terminal, a functional group represented by S⁻ or SR. The silver is bonded to S⁻ or sulfur in SR. The R is a hydrogen atom or a substituent containing a hydrocarbon.

An iodide adsorbing system of an embodiment includes an adsorbent unit having an iodide adsorbent, a supplying unit supplying target medium water including iodide, to the adsorbent unit, a discharging unit discharging the target medium water from the adsorbent unit, a measuring unit measuring concentration of an iodide in the target medium water provided in a supplying unit side, a discharging unit side, or both of the supplying unit side and the discharging unit side, and a controller controlling flow of the target medium water from the supplying unit to the adsorbent unit when a value calculated or obtained from a measured value in the measuring unit reaches set value. The iodide adsorbent includes a support, an organic group bonded to the support, silver, and chloride ions, bromide ions, or both of chloride ions and bromide ions. The organic group has, at the terminal, a functional group represented by S⁻ or SR. The silver is bonded to S⁻ or sulfur in SR. The R is a hydrogen atom or a substituent containing a hydrocarbon.

(Iodine Adsorbent)

An iodine adsorbent of an embodiment includes a support, an organic group having, at the terminal, a functional group bonded to the support and represented by S⁻ or SR, and silver bonded to sulfur in S⁻ or SR. R is a hydrogen atom or a substituent containing a hydrocarbon.

The support of the embodiment is preferably a member capable of imparting to the iodine adsorbent a strength enabling the iodine adsorbent to be put to a practical use. The support for introducing an organic group is preferably one having many hydroxyl groups on the surface, so that the modification ratio of the support with functional groups is increased through the production method described below. For the support, an acidic support, a neutral support obtained by subjecting an acidic support to a neutralization treatment beforehand, or the like may be used. The neutralization treatment includes, for example, treating a support in an additive such as calcium ions. As the support, specifically at least one of silica gel (SiO₂, neutral, acidic), a metal oxide, an acrylic resin and so on can be used.

Examples of the metal oxide may derived from alkoxides and halides that form alminosilicate, titania (TiO₂), alumina (Al₂O₃), zirconia (ZrO₂), cobalt trioxide (CoO₃), cobalt oxide (CoO), tungsten oxide (WO₃), molybdenum oxide (MoO₃ ), indium tin oxide (ITO), indium oxide (In₂O₃), lead oxide (PbO₂), lead zirconate titanate (PZT), niobium oxide (Nb₂O₅), thorium oxide (ThO₂), tantalum oxide (Ta₂O₅), calcium titanate (CaTiO₃), lanthanum cobaltate (LaCoO₃), rhenium trioxide (ReO₃), chromium oxide (Cr₂O₃), iron oxide (Fe₂O₃), lanthanum, chromate (LaCrO₃) and barium titanate (BaTiO₃) and so on.

Among the supports described above, silica gel, titania, alumina and zirconia are preferred because the ratio of hydroxyl groups for bonding organic groups to the surface thereof is high, so that the modification ratio of organic groups is increased.

The support may also be an acrylic resin. The acrylic resin itself has a sufficient strength, so that a strength enabling the iodine adsorbent to be put to practical used can be imparted to the iodine adsorbent, and the acrylic resin also has an ester bond part, so that organic groups can be modified at a high ratio through an ester exchange reaction. The acrylic resin is capable of synthesizing a support having a glycidyl backbone, so that a support can be synthesized with, for example, glycidyl methacrylate as a monomer to modify organic groups at a high ratio.

The size of the support in this embodiment is preferably not less than 100 μm and not more than 5 mm in terms of an average primary particle size. When the average primary particle size of the support is not less than 100 μm and not more than 5 mm, for example, both the level of filling ratio of the iodine adsorbent in a column, a cartridge or a tank and the ease of water conduction can be made satisfactory at the time of performing adsorption of iodine. When the average primary particle size is less than 100 μm, the filling ratio of the iodine adsorbent in the column or the like becomes excessively high to reduce the ratio of voids, so that it is difficult to perform water conduction. On the other hand, when the average primary particle size is more the a 5 mm, the filling ratio of the iodine adsorbent in the column or the like becomes excessively low to increase voids, so that although water conduction is easily performed, a contact area between the iodine adsorbent and wastewater containing iodine decreases, resulting in a reduction in adsorption ratio of iodine by the iodine adsorbent. The average primary particle size of the support is preferably not less than 100 μm and not sore than 2 mm, further preferably not less than 100 μm and not more than 300 μm or not less than 300 μm and not more than 1 mm. An average primary particle size of not less than 100 μm and not more than 300 μm is preferred because the specific surface area of the iodine adsorbent can be increased. An average primary particle size of not less than 300 μm and not more than 1 mm is preferred because a pressure loss caused by water conduction is low.

The average primary particle size can be measured by a screening method. Specifically, the average primary particle size can be measured by screening particles using a plurality of sieves with apertures ranging from 100 μm to 5 mm in accordance with JIS 8901: 2006 “Test powders and test particles”.

In the iodine adsorbent of this embodiment, the size of the adsorbent itself can be adjusted only by changing the size of the support, and it is apparent that for obtaining an adsorbent that is easily handled, the size of the support may be set to a predetermined size. That is, an iodine adsorbent that is easily handled can be obtained without performing operations such as granulation. Since it is not necessary to perform granulation etc., a production process required to obtain an iodine adsorbent that is easily handled can be simplified, so that costs can be reduced.

The organic group in the embodiment bonded to the support and has a functional group represented by S⁻ or SR at the terminal. S⁻ means a thiolate group. SR at the terminal means a functional group such as a thiol group, a sulfide group or a thioester group. When R in SR is large in a functional group, coordination of a metal or at metal ion and adsorption of iodine may be impeded by steric hindrance. Thus, the carbon number of R as a substituent is preferably 6 or less. When a coupling agent having the above-mentioned functional group is reacted with the support, organic groups are introduced into the support. Examples of the coupling agent include silane coupling agents, titanate-based coupling agents and aluminate-based coupling agents. When organic groups are introduced by a coupling agent, a structure between bonding group which bonded to the support and sulfur at the terminal is preferably an alkyl chain or alkoxy chain having a linear chain or a branched chain with a carbon number of 1 to 6.

Silver is bonded to sulfur in the embodiment to function as an iodine adsorbent. When silver is in the form of an ion, a monovalent silver ion is preferred. When silver is zero-valent silver, the zero-valent silver is, for example, one with a silver ion reduced by sulfur in the organic group.

The iodine adsorbent of the embodiment contains chloride ions, bromide ions, or both of chloride ions and bromide ions. The chloride ion and the bromide ion form an ionic bond with at least some of silver ions. Silver chloride and silver bromide have low solubility in water, and some or all of soluble silver ions and silver colloids existing on the surface may be changed into the form of the above-mentioned silver salts to make silver poorly soluble. The iodine adsorbent of the embodiment which contains structures of silver chloride and silver bromide can inhibit silver in the iodine adsorbent from being eluted in target water. Silver in the iodine adsorbent rends to be significantly eluted in target water particularly when target water having a low salt concentration, is subjected to an adsorption treatment, the iodine adsorbent of the embodiment has the advantage that elution of silver ions is small irrespective of the salt concentration of target water. Since silver chloride and silver bromide have a solubility product larger than that of silver iodide, adsorption of iodine can also be performed.

All the supported silver is not necessarily supported as ions and colloids that are easily eluted in water, and therefore all the supported silvers are not required in the form of a poorly soluble silver salt such as silver chloride or silver bromide. Some of silver ions may form an ionic bond with silver salt-derived anions used for introduction of silver.

M_{Cl+Br}/M_{Ag}, an atomic concentration ratio of the sum of chloride ions and bromide ions to silver in the embodiment, is preferably at least 0.3 or more as measured by SEM-EDX (Scanning Electron Microscope-Energy Dispersive X-ray Spectroscopy). This value is determined from an iodine adsorbent having a low solubility of silver and the lowest concentration ratio of chlorine atoms in examples. For the upper limit, the atomic concentration ratio may be 1 or less when washing is completely performed, but since salts are not required to be always washed, the upper limit cannot be specified.

Silver chloride and silver bromide have low water solubility. When silver is eluted from the iodine adsorbent, the iodine adsorbing capability is reduced.

At least some of silver ions form ionic bonds with chloride ions, bromide ions, or both of chloride ions and bromide ions which are not silver salt-derived anions.

The silver salt-derived counter ion of a silver ion is preferably a counter ion that forms a water-soluble salt, such as a fluorine ion, a nitrate ion, a sulfate ion, an acetate ion, a trifluoroacetate ion, a methanesulfonate ion, a trifluoromethanesulfonate ion, a toluenesulfonate ion, a hexafluorophosphate ion or a tetrafluoroborate ion, and particularly, a nitrate ion and a sulfate ion are especially preferred because they are inexpensive and stable, and do not form an anionic metal complex. These counter ions may be contained in the adsorbent.

Zero-valent silver is generated when a silver ion is reduced by a functional group or organic group existing on the surface and represented by S⁻ or SR, or light.

Silver or silver ions comprising the iodine adsorbent in the embodiment may adsorb iodine ions in wastewater. That is, in wastewater, iodine (I) exists in the form of anions such as an iodide ion (I⁻), polyiodide ion (I₃⁻, I₅⁻) and an iodate ion (IO₃⁻), and these anions may interact with silver and silver ions in the iodine adsorbent to adsorb iodine in wastewater.

(Method for Producing Iodine Adsorbent)

A method for producing the iodine adsorbent of this embodiment will now be described. However, the production method described below is one example, and the method is not particularly limited as long as the iodine adsorbent of this embodiment is obtained. It is preferred that after each treatment is performed, filtration, washing with pure water, an alcohol or the like, and drying are performed, followed by performing the next treatment. The method for producing an iodine adsorbent according to an embodiment includes, for example, silver loading to a support, which has an organic group having, at the terminal, a functional group represented by S⁻ or SR, by contact with a solution of organic salt or inorganic salt containing silver; and treating a silver contained support with an aqueous solution containing chloride ions, bromide ions, or both of chloride ions and bromide ions.

First, the above-described support such as silica or titania is proved, and the surface of the support is treated with a coupling agent, which has, at the terminal, a functional group represented by S⁻ or SR, to introduce a thiol part, a sulfide part or the like into the support. Examples of the coupling agent include thiol-based coupling agents such as 3-mercaptopropyltrimethozysilane, 3-mercaptopropyltriethoxysilane and 3-mercaptopropylmethyldimethoxysilane; sulfide-based coupling agents such as bis(triethoxysilylpropylyl)tetrasuifide; and coupling agents such as sulfanyl titanate, sulfanyl aluminum chelate and sulfanyl zircoaluminate.

The reaction of the coupling agent with the support is carried out by a method in which the coupling agent is vaporized and reacted with the support; a method in which the coupling agent is mixed in a solvent, and the mixture is mixed with the support to carry out a reaction; or a method in which a solvent is not used, and the coupling agent is brought into direct contact with the support to carry out a reaction. The amount (ratio) of sulfur introduced into the iodine adsorbent can be adjusted by performing heating or decompression when the coupling agent and the support are reacted.

The reaction solvent may be one that can dissolve a coupling agent having a thiol group and a thiolate group, such as an alcohol and a mixed solvent of an alcohol and water although an aromatic solvent is more preferred. Regarding the reaction temperature, particularly use of an aromatic solvent is preferred because a treatment can be performed at a high temperature, so that the modification ratio of ligands can be increased. On the other hand, in a water-soluble solvent, it is preferred that the reaction is carried out at a lower temperature because the coupling agent is easily hydrolyzed then a condensation reaction between coupling agents also easily occurs.

A support into which organic groups are introduced through a coupling reaction may be used directly in a reaction for silver loading after the support is washed and dried, or may be heated in an alcoholic solvent containing a glucone-1,5-lactone before silver is loaded. As the alcoholic solvent, methanol, ethanol, propanol, butanol or the like can be used. An organic solvent such as acetone, THF, DMSO or DMF can be used depending on a support and an organic group. The heating temperature is preferably not lower than room temperature (25° C.) and not higher than a boiling point although the preferred range varies depending on a solvent. Although the principle of this treatment is not clarified yet, the iodine adsorbing capability of the .iodine adsorbent is improved.

Silver ions are then loaded on the support obtained in the manner described above. For example, mention is made of a method in which, an aqueous solution of a salt of an inorganic acid or organic acid of silver is prepared, the support is then immersed in the aqueous solution, and stirred, or a method in which a column is filled with the support, and the aqueous solution is made to flow into the column.

Examples of the salt of an inorganic acid or organic acid of silver include silver nitrate, silver, sulfate, silver carbonate, silver chlorate, silver nitrite, silver sulfite, silver acetate, silver lactate, silver citrate and silver salicylate, and silver nitrate is preferred from, the viewpoint of solubility in water.

The iodine adsorbent of this embodiment is treated by immersing the iodine adsorbent in an aqueous solution oil a salt containing chloride ions or bromide ions after loading silver, or pouring an aqueous solution containing the salt. The chloride ion or bromide ion exists in the iodine adsorbent while being chemically or physically bonded to silver, or is contained in the form of a salt used in the treatment when washing is not completely performed. Adsorption of iodine can be performed even when a salt remains.

As the salt containing chloride ions, a chloride that is soluble in water and has a pH of around 7, such as lithium chloride, sodium chloride, potassium chloride, rubidium chloride, cesium chloride, magnesium chloride, potassium chloride, strontium chloride, barium chloride or ammonium chloride, is suitable. As the salt containing bromide ions, a bromide having a counter ion similar to that of the foregoing chloride is suitable. A cation that is a counter ion of the chloride ion or bromide ion of the salt may be contained in the iodine adsorbent.

In the production method, described above, a coupling agent is used in introduction of a functional group containing sulfur to the surface of the support, but it is also possible to introduce a functional group containing sulfur after introducing a reactive functional group to the surface of the support. For example, mention is made of a method in which an glycidiyl group is introduced to the surface of a support, and the support is reacted with a compound having a part reactive with the glycidyl group, and a method in which an amino group is introduced to the surface of the support, and the support is reacted with a compound having a part reactive with the amino group.

(Iodine Adsorbing System (Water Treatment System) and Method for Use of Iodine Adsorbent)

An iodine adsorbing system (water treatment system) using the above-described iodine adsorbent, and a method for use thereof will now be described. An iodide adsorbing system (a water treatment system) of an embodiment includes an adsorbent unit having an iodide adsorbent, a supplying unit supplying target medium water including iodide for the iodide adsorbent of the adsorbent unit, a discharging unit discharging the target medium water from the adsorbent unit a measuring unit measuring concentration of an iodide in the target medium water provided in a supplying unit side, a discharging unit side, or both of the supplying unit side and the discharging unit side, and a controller controlling flow of the target medium water from the supplying unit to the adsorbent unit when a value calculated or obtained from a measured value in the measuring unit reaches set value.

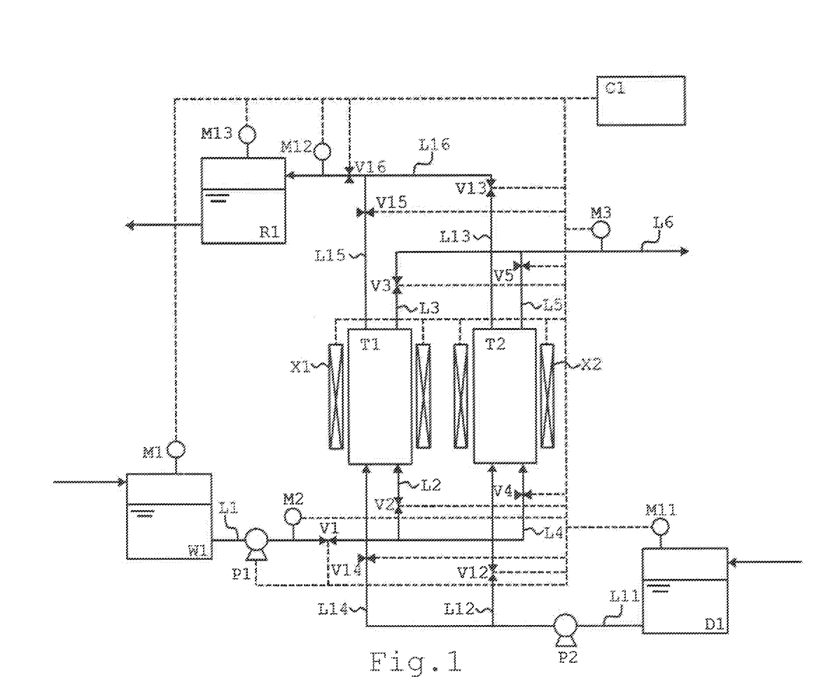

FIG. 1 is a conceptual view showing an outlined configuration of an apparatus used for adsorption of iodine in this embodiment, and a treatment system.

As shown in FIG, 1, in this apparatus, water treatment tanks T1 and T2 filled with the above-described iodine adsorbent are arranged side by side, and contact efficiency promoting units X1 and X2 are provided outside the wafer treatment tanks T1 and T2. The contact efficiency promoting units X1 and X2 may be mechanical stirrers or non-contact magnetic stirrers, but are not essential components, and therefore may be omitted.

The water treatment tanks (adsorbing units) T1 and T2 are connected through wastewater supplying lines (supplying units) L1, L2 and L4 to a wastewater storing tank W1 storing wastewater (target medium water) containing an iodine compound (iodide ions), and are connected to outside through wastewater discharging lines (discharging units) L3, L5 and L6.

The supplying lines L1, L2 and L4 are provided with valves (controlling units) V1, V2 and V4, respectively, and the discharging lines L3 and L5 are provided with valves V3 and V5. The supplying line L1 is provided with a pump P1. Further, the wastewater storing tank W1, the supplying line L1 and the discharging line L6 are provided with concentration measuring units (measuring units) M1, M2 and M3, respectively.

Control of the valves and pump and monitoring of measurements in the measurement apparatus are collectively centralized-managed by a controller C1.

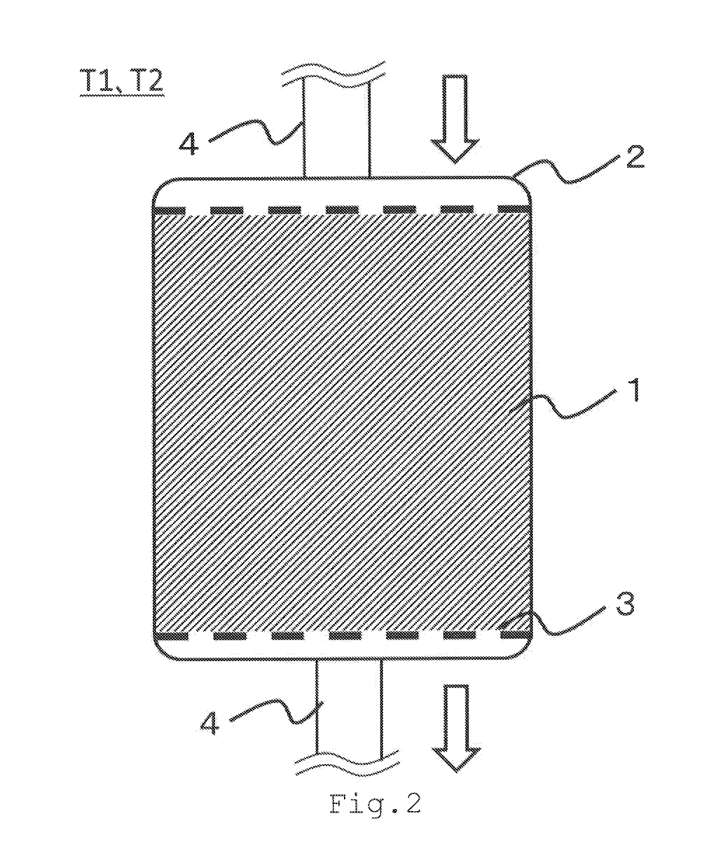

FIG. 2 shows a sectional schematic view of water treatment tanks T1 and T2 connected to pipes 4 (L2 to L4; and filled with the iodine adsorbent. The arrow in FIG. 2 shows a direction in which target water flows. The water treatment tanks T1 and T2 each include an iodine adsorbent 1; a tank 2 storing the iodine adsorbent; and a partition plate 3 for preventing the iodine adsorbent from being leaked to outside the tank 2. The water treatment tanks T1 and 12 may be in a cartridge type form in which the tank 2 itself can be replaced, or may be in a form in which the iodine adsorbent in the tank 2 can be replaced. When there are substances to be adsorbed and collected, in addition to halogens, other adsorbents can be stored in the tank 2.

Halogen adsorption operations using the apparatus shown in FIG. 1 will now be described.

First, wastewater is supplied from, the tank W1 through the wastewater supplying lines L1, L2 and L4 to the water treatment tanks T1 and T2 by the pump P1. At this time, a halogen in wastewater is adsorbed to the water treatment tanks T1 and T2, and wastewater after adsorption of the halogen is discharged to outside through the wastewater discharging lines L3 and L5.

At this time, the contact efficiency promoting units X1 and X2 are driven as necessary to increase the contact area between the iodine adsorbent filling the water treatment tanks T1 and T2 and wastewater, so that efficiency of adsorption of the halogen by the water treatment tanks T1 and T2 can be improved.

Here, the adsorption states of the water treatment tanks T1 and 12 are observed using the concentration measuring unit M2 provided on the supplying unit side and the concentration measuring unit M3 provided on the measuring unit side of the water treatment tanks T1 and T2. When adsorption is successfully performed, the concentration oil the halogen measured by the concentration measuring unit M3 shows a value lower than the concentration of the halogen measured by the concentration measuring unit M2. However, a difference in the concentration of the halogen between the concentration measuring units M2 and M3 arranged on the supplying unit side and the discharging unit side, respectively, decreases as adsorption of the halogen in the water treatment tanks T1 and T2 proceeds.

Therefore, when a predetermined value set beforehand by the concentration measuring unit M3 is reached, so that it is determined that the capability of adsorbing the halogen by the water treatment tanks T1 and T2 is saturated, the controller C1 temporarily stops the pump P1, and closes the valves V2, V3 and V4 to stop supply of wastewater to the water treatment tanks T1 and T2 according to information from the concentration measuring units M2 and M3.

Although not illustrated in FIG. 1, pH of wastewater may be measured by the concentration measuring unit M1, the concentration measuring unit M2, or both of the concentration measuring unit M1 and the concentration measuring unit M2, and adjusted through the controller C1 when pH of wastewater varies, or is that of strong acid or strong alkali and fails out of a pH range suitable for the adsorbent according to this embodiment. pH suitable for adsorption of iodine by the iodine adsorbent of this embodiment is, for example, not less than 2 and not more than 8. Raw city water, city water, agricultural water, industrial water and the like are substantially difficult to treat after pH is adjusted, but these types of water can be treated without adjusting pH.

After the water treatment tanks T1 and T2 are saturated, they are appropriately replaced with water treatment tanks filled with a new iodine adsorbent, and the water treatment tanks T1 and T2 saturated for adsorption of iodine are appropriately subjected to a necessary post-treatment. For example, when the water treatment tanks T1 and T2 contain radioactive iodine, for example, the water treatment tanks T1 and T2 are crushed, then cemented, and stored in an underground facility etc. as radioactive wastes.

In the example described above, a system for adsorbing a halogen in wastewater using a water treatment tank and operations thereof have been described, but a halogen in a waste gas can also be adsorbed and removed by causing a halogen-containing waste gas to pass through a column as described above.

### Example 1

Silica gel (QARiACT-Q6 manufactured by FUJI SILYSIA CHEMICAL LTD.) was classified to particle sizes 300 to 500 μm by a sieving method, 3-mercaptopropyltrimethoxysilane (0.83 kg) and toluene (1.7 kg) were added in a separable flask (5 L), and sufficiently stirred to be homogenized. Thereto was added silica gel (0.50 kg), and the mixture was sufficiently stirred, and heated and stirred under reflux for 9 hours. The mixture was cooled to room temperature, and silica gel was then collected by suction filtration. The obtained silica gel was washed with toluene (1.7 kg), and dried in air to obtain thiol-modified silica gel.

The thiol-modified silica gel (0.58 kg) obtained as described above, glucono-1,5-lactone (0.57 kg) and methanol (9.5 kg) were added in a separable flask (5 L), stirred, and heated at 60° C. for 6 hours. The mixture was cooled to room temperature, and silica gel was then collected by suction filtration. The obtained silica gel was washed with methanol (9.5 kg), and then washed with ion-exchanged water (14.3 kg). Subsequently, the silica gel was dried in air to obtain modified thiol-modified silica gel.

Silver nitrate (0.37 kg) and ion-exchanged water (1.2 kg) were added in a polymer container (20 L), and sufficiently stirred to completely dissolve silver nitrate. Subsequently, the treated thiol-modified silica gel (0.69 kg) obtained as described above was added, and the mixture was stirred at room temperature for 1 hour. Silica gel was collected by suction filtration, and the obtained silica gel was washed with ion-exchanged water until the filtrate became neutral. After being washed; the silica gel was returned to the polymer container, ion-exchanged water (1.2 kg) was added, and the mixture was stirred for 1 hour. Silica gel was separated by suction filtration, and washed with ion-exchanged water. Subsequently, the silica gel was dried in air to obtain silver-loaded silica gel.

The silver-loaded silica gel (2 g) obtained, as described above was added in a glass vial (50 mL), and thereto was added a 3 wt % aqueous sodium chloride solution (40 mL). The vial was shielded against light, and the mixture was then stirred by a mix rotor (60 rpm) for 1 hour. Silica gel was separated by suction filtration to obtain an iodine adsorbent of Example 1.

### Example 2

The silver-loaded silica gel (2 g) obtained in Example 1 was impregnated with ion-exchanged water, and silica gel was separated by suction filtration. A saturated aqueous sodium chloride solution was poured over the separated silica gel, and the silica gel was subsequently washed with ion-exchanged water to obtain an iodine adsorbent of Example 2.

### Example 3

The silver-loaded silica gel (2 g) obtained in Example 1 was impregnated with ion-exchanged water, and silica gel was separated by suction filtration. A saturated aqueous potassium bromide solution was poured over the separated silica gel, and the silica gel was subsequently washed with ion-exchanged water to obtain an iodine adsorbent of Example 3.

### Example 4

3-mercaptopropyltrimethoxysilane (8.6 g) and xylene (10 mL were added in an recovery flask (50 mL), and sufficiently stirred to form a homogeneous solution. Therein was added CARiACT Q-6 (5.1 g in terms of a solid content) containing water in an amount of 25%, and the mixture was heated and stirred under reflux for 5 hours. The flask was cooled to room temperature, and silica gel was then collected by suction filtration. The silica gel was washed with toluene, and then dried under reduced pressure to obtain thiol-modified silica gel.

The thiol-modified silica gel (1.0 g) and methanol (10 mL) were added in an recovery flask (50 mL). Thereto was added glucono-1,5-lactone (0.48 g), and the mixture was heated and stirred under reflux for 6 hours. The flask was cooled to room temperature, and silica gel was then collected by suction, filtration. The silica gel was washed with methanol and ion-exchanged water in order, and then dried under reduced pressure to obtain modified thiol-modified silica gel.

The treated thiol-modified silica gel (0.50 g) was added in a glass vial (20 mL), and a 3 wt % aqueous silver nitrate solution (10 mL) was added. The vial was airtightly closed, and then shielded against Light with an aluminum foil, and the mixture was stirred by a mix rotor (60 rpm) for 1 hour. Silica gel was collected by suction filtration, and washed with ion-exchanged water until the washing liquid became neutral. The washed silica gel was transferred to the screw vial (20 mL) again, ion-exchanged water (10 mL) was added, the vial was shielded against light, and the mixture was then stirred by a mix rotor (60 rpm) for 1 hour. Silica gel was collected by suction filtration, and sufficiently washed with ion-exchanged water followed by drying under reduce pressure to obtain silver-leaded silica gel.

The silver-loaded silica gel (0.30 g) was added in a screw vial (20 mL), and a 3 wt % aqueous sodium chloride solution (6 mL) was added. The vial was shielded against light, and the mixture was then stirred by a mix rotor (60 rpm) for 1 hour. Silica gel was collected by auction filtration, and washed with ion-exchanged water. Subsequently, the silica gel was dried under reduced pressure to obtain an iodine adsorbent of Example 4.

### Example 5

3-mercaptopropyltrimethoxysilane (6.6 g) and toluene (10 mL) were added in an recovery flask (50 mL, and sufficiently stirred to form a homogeneous solution. Therein was added CARiACT Q-6 (5.1 g in terms of a solid content; containing water in an amount of 25%, and the mixture was heated and stirred under reflux for 5 hours. The flask was cooled to room temperature, and silica gel was then collected by suction filtration. The silica gel was washed with toluene, and then dried under reduced pressure to obtain thiol-modified silica gel.

The thiol-modified silica gel (1.9 g) and methanol (20 mL) were added in an recovery flask (50 mL). Thereto was added glucono-1,5-lactone (0.48 g), and the mixture was heated and stirred under reflux for 6 hours. The flask was cooled to room temperature, and silica gel was then collected by suction filtration. The silica gel was washed with methanol (40 mL) and ion-exchanged water (60 mL) in order, and then dried under reduced pressure to obtain modified thiol-modified silica gel as white particles.

The treated thiol-modified silica gel (0.50 g) was added in a screw vial (20 mL), and a 1.5 wt % aqueous silver nitrate solution (20 mL) was added. The vial was shielded against light, and the mixture was then stirred by a mix rotor (60 rpm) for 1 hour. Silica gel was collected by suction filtration, and washed with ion-exchanged water until the washing liquid became neutral. The washed silica gel was transferred to the screw vial (20 mL) again, ion-exchanged water (10 mL) was added, the vial was shielded against light, and the mixture was then stirred by a mix rotor (60 rpm) for 1 hour. Silica gel was collected by suction filtration, and sufficiently washed with ion-exchanged water followed by drying under reduce pressure to obtain silver-loaded silica gel.

The silver-loaded silica gel (0.50 g) was added in a screw vial (20 mL), and a 3 wt % aqueous sodium chloride solution (6 mL) was added. The vial was shielded against light, and the mixture was then stirred by a horizontal-type mix rotor (rotation number: 60 rpm) for 1 hour. Silica gel was collected by suction filtration, and washed with ion-exchanged water. Subsequently, the silica gel was dried under reduced pressure to obtain an iodine adsorbent of Example 5.

### Comparative Example 1

The silver-loaded silica gel of Example 1 was used as a comparative example of an iodine adsorbent which was not treated with chlorine or bromine.

[Silver Elution Test]

Ion-exchanged water (10 mL) and an adsorbent (20 mg) were added in a vial (20 mL), and the mixture was stirred an room temperature for 1 hour on a mix rotor at 60 rpm. Immediately after stirring, the mixture was filtered using a 0.2 μm cellulose membrane filter.

The concentration of silver in the filtrate in the silver elution test was quantitatively determined (ppm-g unit) by inductively coupled plasma atomic emission spectrometry (ICP-AES), and the obtained value was defined as a silver elution amount. For the ICP-AES measurement, 730-ES manufactured by Agilent Technologies, Inc. was used.

[Iodine Adsorption Test]

Potassium iodide (0.500 g) was added in a 1 L measuring flask, and diluted in measuring cylinder with pure water to prepare a 500 mg/L aqueous potassium iodide solution. As a solution containing various kinds of ions that could be obstruct iodine adsorption, an artificial sea water-added 500 mg/L aqueous potassium iodide containing artificial sea water (1.000 g of MARINE ART SF-1 manufactured by Tomita Pharmaceutical Co., Ltd.; NaCl: 22.1 g, MgCl₂.6H₂O: 9.9 g, CaCl₂.2O: 1.5 g, Na₂SO₄: 3.9 g, KCl: 0.61 g, NaHCO₃: 0.19 g, KBr: 96 mg, Na₂B₄O₇.10H₂O: 78 mg, SrCl₂: 13 mg, NaF: 3 mg, LiCl: 1 mg, KI: 81 μg, MnCl₄.4H₂O: 0.6 μg, CoCl₂.6H₂O: 2 μg, AlCl₃.6H₂O: 8 μg, FeCl₃.6H₂O: 5 μg, Na₂WO₄.2H₂O: 2 μg and (NH₄)₆Mo₇O₂₄. 4H₂O: 18 μg per 38.4 g of MARINE ART) and potassium iodide (0.500 g) was prepared. These two solutions were used as target water.

Target water (10 mL) and an adsorbent (20 mg) were then added in a vial (20 mL), and stirred at room temperature for 1 hour in a mix rotor at 60 rpm. Immediately after stirring, the mixture was filtered using a 0.2 μm cellulose membrane filter.

The concentration of iodine in the filtrate in the iodine adsorption test was quantitatively determined by inductively coupled plasma cuss spectrometry (ICP-MS). For the ICP-MS measurement, 7700x manufactured by Agilent Technologies, Inc. was used. For the adsorption amount, a concentration of residual iodine was calculated from a difference in amount of residual iodide ions between the sample and a blank obtained by loaded out similar operations without the adsorbent. An iodine adsorption amount was calculated from the concentration of residual iodine, and an iodine adsorption amount was determined from the amount of the adsorbent used.

[SEM-EDX Analysis]

SEM-EDX measurement, was performed by dispersing a sample in an appropriate amount on a carbon tape, and directly observing the sample without metal deposition. The SEM was Miniscope TM3000 manufactured by Hitachi High-Technologies Corporation, and Quantax 70 manufactured by Bruker Company was used for EDX. The accelerating voltage of electron beams was 15 kV, the observation magnification was 2000X, and the observation mode was a secondary electron image mode. The observation object was an area of about 1250 μm² at the central portion of a silica gel particle. In the case where there was a defect at the central portion, measurement was performed while the defect was avoided. Measurement was performed three times for each of the samples of Examples 1 to 5.

The results of conducting the above-described tests using the chlorine or bromine-treated silver-loaded silica gel obtained in Examples 1 to 5 are shown in Table 1. The silver elation amount is a concentration of silver [mg/L] in the elution test solution. The adsorption amount A is an adsorption amount [mg-I/g] for the 500 mg/L aqueous potassium iodide solution. The adsorption amount B is an adsorption amount [mg-I/g] for the artificial sea water added 500 mg/L ague one potassium iodide solution. Atomic concentration ratios determined by SEM-EDX are shown in Table 2. The atomic concentration ratio in Table 2 is a value obtained by dividing the concentration of chlorine and bromine atoms by the silver atomic concentration in semi-quantitative determination by SEM-EDX.

TABLE 1

| | Silver | | |
|---|---|---|---|
| | elution | Adsorption | Adsorption |
| Iodine | amount | amount A | amount B |
| adsorbent | [mg/L] | [mg-I/g] | [mg-I/g] |
| Example 1 | 0.10 | 8 | 52 |
| Example 2 | 0.02 | 5 | 47 |
| Example 3 | 0.01 | 16 | 32 |
| Exampie 4 | 0.06 | 2 | 25 |
| Example 5 | 0.12 | 12 | 31 |
| Comparative | 34.76 | 27 | 39 |
| Example 1 | | | |

TABLE 2

| | M_{Cl+Br}/M_{Ag} | | | |
|---|---|---|---|---|
| | Atomic concentration ratio | | | |
| Iodine | [(Cl + Br)/Ag] | | | |
| adsorbent | Particle 1 | Particle 2 | Particle 3 | Average |
| Example 1 | 0.33 | 0.40 | 0.42 | 0.38 |
| Example 2 | 0.38 | 0.38 | 0.36 | 0.38 |
| Example 3 | 0.41 | 0.37 | 0.36 | 0.38 |
| Example 4 | 1.11 | 0.95 | 0.70 | 0.92 |
| Example 5 | 0.47 | 0.57 | 0.57 | 0.54 |

From the silver elation amounts in Table 1, it is apparent that in Comparative Example 1 where the adsorbent was not treated with chlorine or bromine, silver was elated at a high concentration of 34.76 mg/L, whereas in the iodine adsorbents treated with chlorine or bromine, which were obtained in examples, silver was almost not diluted.

When attention is given to the adsorption amount A, it is found that the adsorbents of examples, which were treated with chlorine or bromine, tended to have a reduced adsorption amount as compared to the adsorbent of Comparative Example 1.However, for the adsorption amount B where multiple kinds of ions coexisted, the adsorption amount was greater as compared to Comparative Example 1 except for Examples 4 and 5. Examples 4 and 5 are different from other examples and Comparative Example 1 in that humidity-controlled silica gel is used for the raw material, and particularly from comparison between Examples 1 to 3 and the comparative example where silica gel that is not humidity-controlled is used, it can be said that the adsorbent amount tends to be increased, by a treatment with chlorine or bromine. The reason for this is currently unknown, but it is evident that the adsorbents of examples can be used as an iodine adsorbent even when treated with chlorine or bromine.

When attention is given to Table 2, it is apparent that when chlorine or bromine, the atomic number of which is smaller than that of silver, exists on the surface, elution of silver can be suppressed. It is apparent that in all of Examples 1 to 5, sodium chloride or potassium bromide remains because sodium or potassium is detected at the same time. Thus, it is apparent that chlorine or bromine in an amount equal to that of silver is not required, for making silver hardly soluble in an iodine adsorbent formed of a silver-loaded material. It is considered that among silver atoms existing on the surface of the iodine adsorbent, those having particularly high solubility were converted into silver chloride or silver bromide by selectively reacting with chlorine or bromine through a chlorine or bromine treatment, so that silver became hardly soluble.

As described above, it has been found from SEM-EDX measurement that sodium chloride or potassium bromide remains, but it has become apparent that even when salts remain, the iodine adsorbent successfully functions as an iodine adsorbent.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fail within the scope and spirit of the inventions.

What is claimed is:

1. An iodine adsorbent comprising a support, an organic group bonded to the support, silver, and chloride ions, bromide ions, or both of chloride ions and bromide ions, wherein the organic group has, at the terminal, a functional group represented by S⁻ or SR, the silver is bonded to S⁻ or sulfur in SR, and the R is a hydrogen atom or a substituent containing a hydrocarbon.

2. The adsorbent according to claim 1, wherein M_{Cl+Br}/M_{Ag}, an atomic concentration ratio of the sum of chloride ions and bromide ions to the silver is 0.3 or more.

3. The adsorbent according to claim 1, wherein the functional group represented by SR is a functional group selected from a thiol group, a thioester group and a sulfide group.

4. A water treatment tank storing an iodine adsorbent, wherein the iodine adsorbent comprising a support, an organic group bonded to the support, silver, and chloride ions, bromide ions, or both of chloride ions and bromide ions, wherein the organic group has, at the terminal, a functional group represented by S⁻ or SR, the silver is bonded to S⁻ or sulfur in SR, and the R is a hydrogen atom or a substituent containing a hydrocarbon.

5. The tank according to claim 4, wherein M_{Cl+Br}/M_{Ag}, an atomic concentration ratio of the sum of chloride ions and bromide ions to the silver is 0.3 or more.

6. The tank according to claim 4, wherein the functional group represented by SR is a functional group selected from a thiol group, a thioester group and a sulfide group.

7. An iodide adsorbing system comprising:
an adsorbent unit having an iodide adsorbent;
a supplying unit supplying target medium water including iodide, to the adsorbent unit;
a discharging unit discharging the target medium water from the adsorbent unit;
a measuring unit measuring concentration of an iodide in the target medium water provided in a supplying unit side, a discharging unit side, or both of the supplying unit side and the discharging unit side; and
a controller controlling flow of the target medium water from the supplying unit to the adsorbent unit when a value calculated or obtained from a measured value in the measuring unit reaches set value,
wherein the iodide adsorbent comprising a support and, an organic group bonded to the support, silver, and chloride ions, bromide ions, or both of chloride ions and bromide ions, the organic group having, at the terminal, a functional group represented by S⁻ or SR, the silver being bonded to S⁻ or sulfur in SR, and the R being a hydrogen atom or a substituent containing a hydrocarbon.

8. The system according to claim 7, wherein M_{Cl+Br}/M_{Ag}, an atomic concentration ratio of the sum of chloride ions and bromide ions to the silver is 0.3 or more.

9. The system according to claim 7, wherein the functional group represented by SR is a functional group selected from a thiol group, a thioester group and a sulfide group.
